(19) United States
(12) Patent Application Publication
(10) Pub. No.: US 2026/0307592 A1
(43) Pub. Date: Oct. 8, 2026

(54) SINGLE ARM CARRIER

(71) Applicant: SARIS EQUIPMENT LLC, Edison, NJ (US)

(72) Inventors: James Joseph Weinert, Belleville, WI (US); Benjamin Raymond Bass, Fitchburg, WI (US); Dustin Lee Kohl, Verona, WI (US); Ryan Scot Lutzen, Madison, WI (US); Jeffery Thomas Iverson, Madison, WI (US)

(73) Assignee: SARIS EQUIPMENT LLC, Edison, NJ (US)

(21) Appl. No.: 19/461,547

(22) Filed: Jan. 27, 2026

Related U.S. Application Data
(60) Provisional application No. 63/750,101, filed on Jan. 27, 2025.

(51) Int. Cl. B60R 9/10; B60D 1/58

(52) U.S. Cl. CPC B60R 9/10; B60D 1/58

(57) ABSTRACT

An adjustable arm bike carrier system is provided that can include a base attachable to a motor vehicle, and at least one support member attached to the base and configured to support the tires of a bicycle. The system also includes a pivot axle, and an adjustable hook arm configured to rotate about the pivot axle in both directions and hold the tire. The hook arm can include a hook portion having a mechanical constraint for compressing the tire of the bicycle.

### CROSS-REFERENCE TO RELATED APPLICATION

The present invention claims priority to U.S. patent application Serial No. 63/750,101, filed Jan.27, 2025, which is hereby incorporated by reference in its entirety.

### FIELD

The present invention relates to carrier systems for mounting on vehicles and, more particularly, to carrier systems for carrying equipment, such as bicycles.

### BACKGROUND

Many types of carriers and racks have been used conventionally to carry bicycles on the rear of motors vehicles, including carrier systems that attach to the hitch of a motor vehicle. However, various complications to the safe carrying of the bicycles can arise due to the size or weight of the bicycle or when carrying multiple bicycles on a single rack.

For example, when transporting multiple bikes on a vehicle, a common concern is avoiding interference between bikes (e.g., two bicycles contacting each other). Interference can cause damage to the bikes and may lead customers to mount bikes incorrectly on the rack. One of the most common interferences on tray-style hitch racks is between the handlebars of one bike and the seat or wheel or frame of the next nearest bike.

Similarly, many conventional bicycle carriers secure bicycles by clamping or contacting the frame or fork of the bicycle, which can cause wear and tear on the frame, or worse, compromise the function of the fork, particularly for bicycles with suspension forks. Additionally, some conventional bicycle carriers do not hold the bicycles securely enough to withstand the vibrations and jostling associated with the driving of a motor vehicle. As such, bicycles can be susceptible to movement while in the carrier, which can result in interference between multiple bicycles, which can cause wear on the bicycles over time. Likewise, for hitch-type bicycle carriers, in some conventional carriers the hitch connection can become loose over time, thereby causing an unsecured connection between the bicycle carrier and the hitch receiver.

Additionally, many existing bicycle carriers require users to have a considerable amount of strength or requires multiple users to operate the carrier safely and to prevent damage to the bicycles. Finally, some existing bicycle racks can be limited in the size of bicycles that it can securely carry. In some instances, carriers cannot effectively accommodate bicycles with wheels that are too large, or children’s bicycles where the dimensions are too small.

The present application addresses these and other needs related to bicycle carriers and in particular, bicycle carriers attached to motor vehicles.

### SUMMARY

In a first aspect, an adjustable arm bike carrier system is provided. The system comprises a base configured to attach to a motor vehicle, and at least one support member attached to the base and configured to support the first and second tires of a bicycle. The system also includes a pivot axle, and an adjustable hook arm operatively connect to the at least one support member or the base at the pivot axle. The hook arm is configured to rotate about the pivot axle in both directions and configured to securely hold the front or rear tire of the bicycle on the bike carrier system. The hook arm comprises an arm portion operatively connected to the pivot axle and a hook portion having a mechanical constraint. The mechanical constraint causes the hook portion to compress the front or rear tire of the bicycle and is unidirectional to continually provide contact of the hook portion with the tire.

In another aspect, the hook arm further comprises a trigger located on or attached to the hook arm, wherein the hook portion is operatively connected to the trigger, and wherein upon activation of the trigger, the hook portion is configured to extend outwardly.

In another aspect, the system further comprises an upper stop located on or about the at least one support member and configured to prevent upward rotation of the hook arm about the pivot axle past a predetermined angle relative to horizontal, and wherein the hook arm is positioned at an angle such that hook portion needs to extend away from the tire for the hook arm to rotate toward the at least one support member. In a further aspect, the predetermined angle is between approximately 45° and approximately 75° relative to horizontal. In a further aspect, the predetermined angle is approximately 52° relative to horizontal. In a further aspect, the upper stop prevents the hook from contacting a frame or fork, fenders, and/or rack of the bicycle.

In another aspect, the system further comprises a lower stop located on or about the at least one support member and configured to prevent downward rotation of the hook arm about the pivot axle past approximately 0 degrees relative to horizontal.

In another aspect, the hook arm is operatively connected to the mechanical locking mechanism via a linkage, wherein upon activation of the trigger, at least a portion of the hook arm is configured to extend outwardly via the mechanical locking mechanism.

In another aspect, the trigger is located at a proximal end of the hook portion.

In another aspect, the mechanical locking mechanism is a ratchet mechanism. In a further aspect, activation of the trigger causes the linkage to rotate a ratchet arm within the ratchet mechanism, such that the ratchet arm releases from the mechanism to allow the portion of the hook arm to extend.

In another aspect, the mechanical constraint is a spring or an elastomer. In a further aspect, the spring or elastomer is a constant force spring.

In a second aspect, a carrier system comprising a bike interference adjustment device is provided. The system comprises a base configured to attach to a motor vehicle; and at least one tire support member attached to the base, wherein the at least one tire support member is configured to support the tires of at least one bicycle; The system further includes at least one interference adjustment device located on the at least one tire support member, wherein the at least one interference adjustment device is are configured to raise and lower a tire of the at least one bicycle located on the at least one tire support member.

In another aspect, the at least one interference adjustment device is configured to raise and lower the front or back tire of the at least one bicycle to different positions.

In another aspect, the location of the at least one interference adjustment device is adjustable along the length at least one tire support member.

In a third aspect, a hitch tightening mechanism for a bike carrier system is provided. The hitch tightening mechanism comprises a stinger tube connected to a base of the bike carrier system, wherein the stinger tube is configured for placement within a hitch receiver of a motor vehicle at a proximal end of the stinger tube, a linkage located within the stinger tube, and a cam and a cam follower operatively connected to one another and located within the stinger tube, wherein the linkage is connected to the cam follower at a proximal end of the linkage. The hitch tightening mechanism also includes a drive end located at a distal end of the stinger tube, wherein the linkage is connected to the drive end at a distal end of the linkage. The stinger tube includes an aperture on the stinger tube adjacent to the cam. To tighten the connection of the stinger tube within the hitch receiver of the motor vehicle, the drive end is configured to rotate causing the linkage to drive the cam follower, thereby rotating a top end of the cam to a location outside the aperture of the stinger tube, where the cam engages with the inside of the hitch receiver.

In another aspect, the linkage is a rod that is attached to the cam follower at a proximal end and the drive end at the distal end. In a further aspect, the rod is a threaded rod and/or a bent rod.

### BRIEF DESCRIPTION OF THE DRAWINGS

FIG. 1A displays a perspective view of a bicycle carrier system featuring an adjustable hook arm in accordance with one or more embodiments.

FIG. 1B displays a diagram of an adjustable hook arm of a bicycle carrier system in accordance with one or more embodiments.

FIG. 1C displays a diagram of a bottom portion of the adjustable hook arm of a bicycle carrier system in accordance with one or more embodiments.

FIGS. 1D-1E display diagrams of a bicycle carrier system featuring an adjustable hook arm and the attachment to wheels of varying diameters in accordance with one or more embodiments.

FIGS. 1F-1G display diagrams of the adjustable hook arm in a use position displaying the upper stop (FIG. 1F) and in a storage position displaying the lower stop (FIG. 1G) in accordance with one or more embodiments.

FIGS. 1H-1I display diagrams of the adjustable hook arm in a use position displaying the upper stop (FIG. 1H) and in a storage position displaying the lower stop (FIG. 1I) in accordance with one or more embodiments and include discrete rotational detents that constrain the arm to a specific angle in accordance with one or more embodiments.

FIG. 2A displays a diagram of a carrier system that includes at least one bike interference adjustment device in accordance with one or more embodiments.

FIGS. 2B-2C display images of a bike interference adjustment device in multiple configurations in accordance with one or more embodiments.

FIGS. 2D-2E display diagrams of a carrier system with the at least one bike interference adjustment device showing removal of interference between two bicycles by the interference adjustment device in accordance with one or more embodiments.

FIG. 2F displays a diagram of a bike interference adjustment device in a wheel chock mode (tire to be positioned on lower surface of interference adjustment device) and in a riser block mode (tire to be position on upper surface of interference adjustment device) in accordance with one or more embodiments.

FIG. 2G displays a diagram of a bike interference adjustment device showing the movement of the interference adjustment device to different locations along the length of the tire support member in accordance with one or more embodiments.

FIGS. 3A-3B displays diagrams of a first embodiment of a hitch tightening mechanism for a bike carrier system, including the connection to the hitch receiver of a vehicle (FIG. 3B) in accordance with one or more embodiments.

FIGS. 3C-3F display diagrams of a cam mechanism of the first embodiment of a hitch tightening mechanism in two positions in accordance with one or more embodiments, including a tight position (cam engaged with hitch receiver, FIGS. 3C-3D) and a loose position (cam not engaged with hitch receiver, FIGS. 3E-3F).

FIGS. 3G-3I display diagrams of a second embodiment of a hitch tightening mechanism for a bike carrier system in accordance with one or more embodiments.

FIG. 3J displays diagrams of a stinger tube of a second embodiment of a hitch tightening mechanism having an opening for a bent pin in accordance with one or more embodiments.

FIG. 3K displays a drive end of a hitch tightening mechanism that can be rotated with or without the use of a separate tool in accordance with one or more embodiments.

FIG. 3L displays an adapter sleeve for a stinger tube of a hitch tightening mechanism in accordance with one or more embodiments.

FIG. 4A-4D displays diagrams of another embodiment of a hitch tightening mechanism for a bike carrier system in accordance with one or more embodiments.

FIGS. 4E-4F display diagrams of the hitch tightening mechanism embodiment of FIGS. 4A-4D in an initial position and in an installed position (i.e., engaged with the hitch receiver) without the adapter sleeve for connection to smaller hitch receivers (FIG. 4E) and with an adapter sleeve for connection to larger hitch receivers (FIG. 4F).

### DETAILED DESCRIPTION

In a first aspect, the present application relates to a bicycle carrier system having an adjustable hook arm for securing a tire (e.g., front tire) of a bicycle. In this aspect, the bicycle carrier system can include a base capable of attachment to a motor vehicle (e.g., via a hitch receiver), and at least one support member that can be attached to the base and configured to support the first and second tires of a bicycle. The bicycle carrier can further include a pivot axle and an adjustable hook arm operatively connected to the at least one support member at the pivot axle. In one or more embodiments, the hook arm can be configured to rotate about the pivot axle in both directions and configured to securely hold the front or rear tire of the bicycle on the bike carrier system. The hook arm can include a trigger, where upon activation of the trigger, a portion of the hook arm is configured to extend outwardly (e.g., via a ratchet mechanism). The hook arm can also include a mechanical constraint (e.g., spring or elastomer) that compresses the bike tire, thereby holding it in place during use. In one or more embodiments, the bicycle carrier can further include upper and lower stops located on or about the at least one support member. The upper stop prevents upward rotation of the hook arm about the pivot axle past a predetermined angle relative to horizontal, while the lower stop prevents downward rotation of the hook arm about the pivot axle past horizontal.

In a second aspect, the present application relates to a bicycle carrier system that include an interference adjustment mechanism. In this aspect, the bicycle carrier system can include a base configured to attach to a motor vehicle (e.g., via a hitch receiver). The bicycle carrier system further includes at least one tire support member attached to the base. The at least one tire support member is configured to support a tire of at least one bicycle. The carrier also includes fat least one interference adjustment device located on the at least one tire support member, where the at least one interference adjustment device is configured to raise and lower the respective a tire of the at least one bicycle located on the at least one tire support member In one or more embodiments, each interference adjustment device includes a first surface (e.g., non-horizontal surface) at a proximal end of the interference adjustment device and located above a surface of the respective tire support member. In such an embodiment, each interference adjustment device also includes a second surface adjacent to the first surface and at a distal end of the interference adjustment device. The second surface is a generally horizontal surface located above the first surface. In certain embodiments, respective tires of first and second bicycles being held by the system are configured to rest on the first surface or the second surface of respective interference adjustment devices such that the interference adjustment devices raise the respective tires of the first and second bicycles relative to the adjacent tires of the first and second bicycles and thereby eliminate interference between handlebars of the first and second bicycles and seats of the first and second bicycles.

In a third aspect, a hitch tightening mechanism for a bike carrier system is disclosed. The hitch tightening mechanism can include a stinger tube connected to a base of the bike carrier system, wherein the stinger tube can be configured for placement within a hitch receiver of a motor vehicle at a proximal end of the stinger tube. The hitch tightening mechanism also includes a linkage (e.g., rod, threaded rod) located within the stinger tube, as well as a cam and a cam follower operatively connected to one another and located within the stinger tube. The linkage is connected to the cam follower. The hitch tightening mechanism can also include a drive end located at a distal end of the stinger tube, such that the linkage is operatively connected to the drive end at a distal end of the rod. The stinger tube can also include an aperture on the stinger tube. To tighten the connection of the stinger tube within the hitch receiver, the drive end is configured to rotate, causing the linkage to drive the cam follower, and thereby rotating a top end of the cam outside the aperture of the stinger tube where the cam engages with the inside of the hitch receiver.

These and other aspects of the bicycle carrier systems of the present application are described in further detail below, with reference to the accompanying drawings figures, in which one or more illustrated embodiments and/or arrangements of the systems are shown.

The systems of the present application are not limited in any way to the illustrated embodiments and/or arrangements. It should be understood that the systems as shown in the accompanying figures are merely exemplary of the systems of the present application, which can be embodied in various forms as appreciated by one skilled in the art. Therefore, it is to be understood that any structural and functional details disclosed herein are not to be interpreted as limiting the present systems and methods, but rather are provided as a representative embodiment and/or arrangement for teaching one skilled in the art one or more ways to implement the present systems and methods. It should be understood that, as used in the present application, the term “approximately” when used in conjunction with a number refers to any number within 1%, 2%, or 3% of the referenced number, including the referenced number.

### Bicycle Carrier System Having an Adjustable Hook Arm

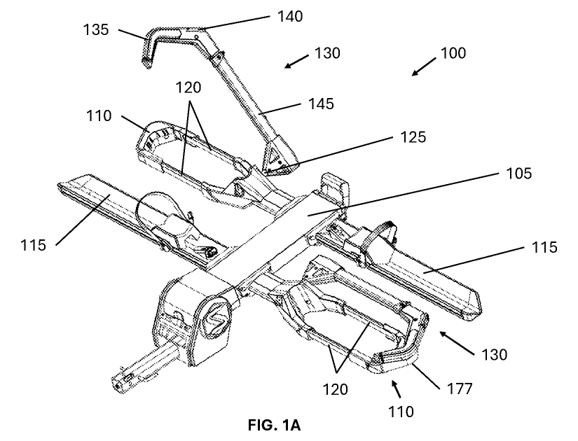

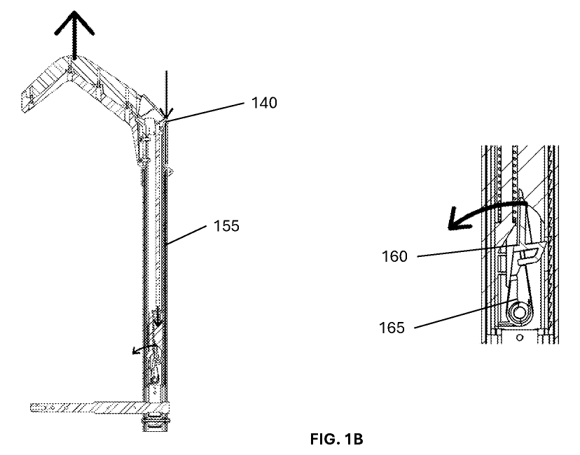

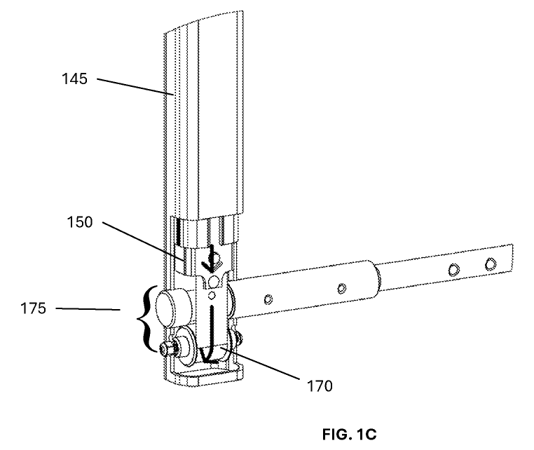

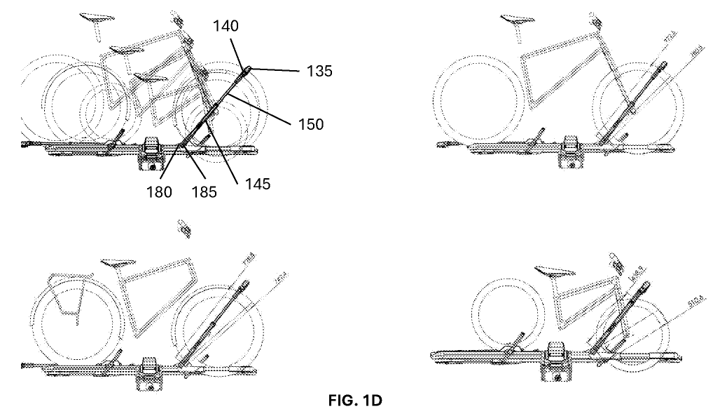

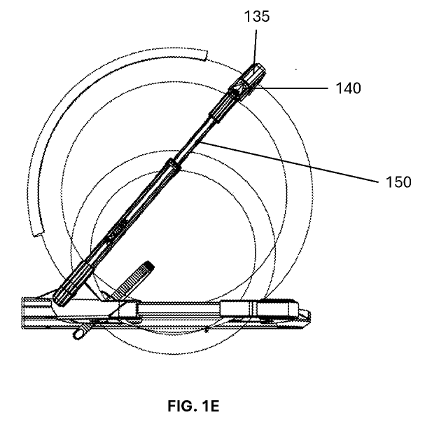

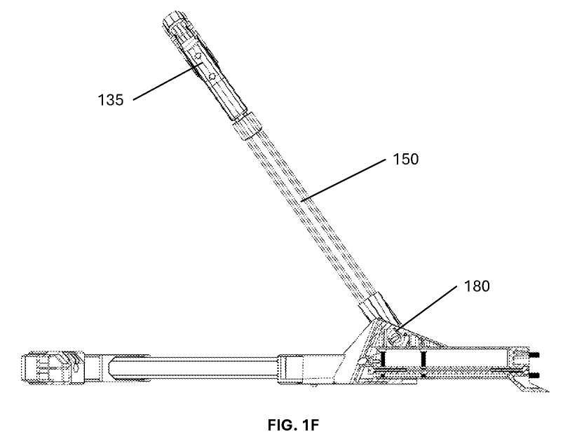

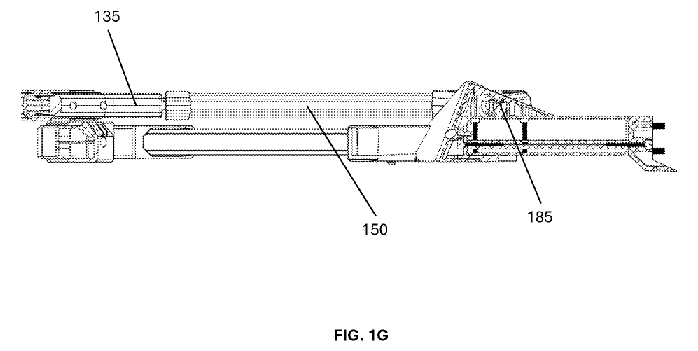

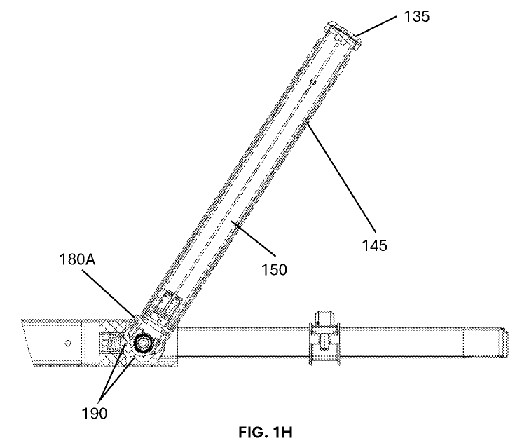

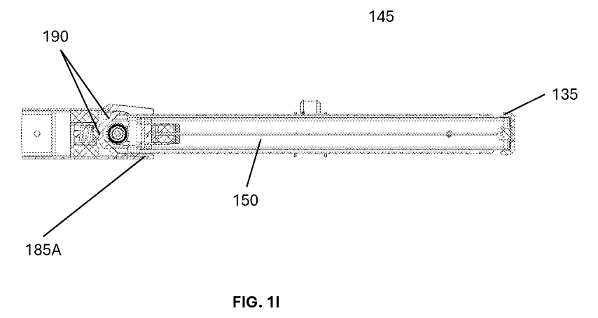

FIGS. 1A-1E displays various aspects of a bicycle carrier system featuring an adjustable hook arm in accordance with one or more embodiments. With reference now to FIGS. 1A-1E, in accordance one or more embodiments the bicycle carrier system 100 includes a base 105 configured to attach to a motor vehicle. As exemplified in FIG. 1A, in one or more embodiments the base 105 can attach to the motor vehicle via an attachment to a vehicle’s hitch receiver (e.g., via a stinger tube). In other embodiments, the base 105 can attached to a vehicle via bumper or back door of the vehicle in any number of manners as known and understood in the art. The system 100 further includes at least one support member configured to support one or both tires of a bicycle. As illustrated in FIGS. 1A-1E, in one or more embodiments, the at least one support members include a first support member 110 that is attached to one end of the base 105, and a second support member 115 that is attached to an opposing end of the base 105. The first supper member 110 is configured to support a first tire of the bicycle (e.g., front tire) and the second support member 115 is configured to support a second tire (e.g. back tire) of the bicycle. As exemplified in FIGS. 1A-1D, in one or more embodiments the first support member 110 can be generally oval shaped such that the tire of the bicycle fits within the opening of the oval shape. In one or more embodiments, the first support member 110 can have adjustable, parallel arms 120 that extend and contract the accommodate bicycle tires of different sizes. In one or more embodiments, the one or more support members (e.g., 110, 115) can be in the form of a tray, multiple trays, or a single base or multiple bases, for example. Thus, for example, in certain embodiments, instead of first and second tire support members supporting the respective tires of a single bicycle, a single tray can support both tires of a bicycle. Likewise, in at least one embodiment, the tires of multiple bicycles can be supported by a single tray or platform.

The carrier system 100 can further include a pivot axle 125 and a hook arm 130. The hook arm 130 is operatively connected to the base and/or the first support member 110 at the pivot axle 125. The hook arm 130 is configured to rotate about the pivot axle 125 in both directions and it is configured to securely hold the tire of the bicycle at a hook portion 135 of the hook arm 130. The hook arm 130 also includes a trigger 140 located on or attached to the hook arm 130. In at least one embodiment as exemplified in FIG. 1A, the trigger 140 is located at proximal end of the hook portion 135. In one or more embodiments, the hook arm 130 can further comprise an outer tube 145, and inner adjustable arm 150 located within the outer tube 145. In one or more embodiments, the inner adjustable arm 150 is configured to extend or retract longitudinally. In one or more embodiments, the inner adjustable arm 150 can be a telescoping arm. The outer tube 145 is operatively connected to the pivot axle 125.

In one or more embodiments, the hook portion of the hook arm 130 is operatively connected to the trigger 140 such that upon activation of the trigger 140, at least a portion of the hook arm 130 is configured to extend outwardly. In one or more embodiments, the hook arm 130 can be operatively connected to operatively connected to a mechanical locking mechanism 155, such as a ratchet mechanism, via a linkage 165. In one or more embodiments, upon activation of the trigger 140 by the user, the hook arm 130 is configured to extend outwardly via the mechanical locking mechanism 155. In one or more implementations, the inner adjustable arm 150 at its distal end is operatively connected to the trigger 140, and at its proximal end operatively connected to a mechanical locking mechanism 155, such as a ratchet mechanism, via a linkage 165. In one or more embodiments, upon activation of the trigger 140 by the user, the inner adjustable arm 150 is configured to extend outwardly from a distal end of the outer tube 145 via the mechanical locking mechanism 155. In one or more embodiments, the trigger 140 can be activated by the user by pressing down and holding the trigger 140.

In one or more embodiments as exemplified in FIG. 1B, wherein the mechanical locking mechanism 155 is a ratchet mechanism, the ratchet mechanism 155 includes a ratchet arm 160 that is connected to a linkage 165 of the inner adjustable arm 150. When the trigger 140 is activated (e.g., press and/or hold), the linkage 165 rotates the ratchet arm 160 so that it releases, allowing a portion of the hook arm 130 (e.g., inner adjustable arm 150) to extend (e.g., extend away from the pivot axle 125). When the trigger 140 is released by the user, the ratchet arm 160 is re-engaged, thereby preventing the inner adjustable arm 150 from extending from away from the pivot axle. In other words, in at least one embodiment, the inner adjustable arm 150 can only extend when the trigger 140 is activated.

The hook arm 130 further includes a mechanical constraint 170, such as a spring or elastomer (e.g., constant force spring). In one or more embodiments, the mechanical constraint (e.g., spring or elastomer) 170 can be located at a proximal end of the arm portion, such as, in certain embodiments as exemplified in FIG. 1C, within the outer tube 145 and operatively connected to the inner adjustable arm 150. In one or more embodiments, the mechanical constraint 170 is located throughout the arm portion of the hook arm 130. In at least one embodiment, the mechanical constraint 170 is located at a distal end of the arm portion. As exemplified in FIG. 1C, the compact nature of the spring or elastomer 170 allows it to be placed inside the adjustable arm 150, near or about the pivot axle 125 (see FIG. 1A). In one or more embodiments, a passthrough clearance 175 cut on the axle 125 that is inside the arm 130 creates a volume for the spring or elastomer 170 to pass by the axle 125. In one or more embodiments, the mechanical constraint (e.g., spring or elastomer) 170 causes the hook portion to compress the front or rear tire of the bicycle and the mechanical constraint of the hook portion is unidirectional to continually provide contact of the hook portion with the tire.

In at least one embodiment, the spring or elastomer 170 exerts a constant downward force on the inner adjustable arm 150. In other words, the spring or elastomer 170 provides an automatic arm retraction of the hook arm 130, and, in certain embodiments, a constant downward force of the hook portion 135 on the tire of the bicycle when the bicycle is loaded into the carrier 100.

Thus, in one or more embodiments, when a bicycle is loaded onto the carrier system 100, the constant downward force of the mechanical constraint (e.g., spring or elastomer) 170 cause the hook arm 130 to provide a constant clamp on the front tire or rear tire of the bicycle. In one or more embodiments, the outer tube 145 is welded to the axle 125 and extends beyond both sides of the axle 125, and one side of the outer tube 145 contains the inner adjustable arm 150 while the other side of the outer tube 145 contains the retracting mechanism 155. This allows maximum space to be dedicated to the adjustable arm 150 coverage range.

In one or more embodiments, a spring or elastomer can bias the hook to the closest position relative to the pivot axle in addition to the mechanical constraint 170 that causes the hook portion to compress the bicycle tire, and in certain implementations, this spring or elastomer is a constant force spring.

The automatic arm retraction feature of the adjustable arm 150 provides many benefits, including holding security of the bicycle in the event of a flat tire. Specifically, the hook portion 135 secures to the outside treads of the bike tire and if the tire were to flatten during transport of the bike in the carrier 100, the automatic arm retraction mechanism will keep tight contact with the bike tire, even while it deflates. More specifically, the mechanical locking mechanism (e.g., ratchet mechanism) 155 prevents the hook arm 130 from extending and ensures that the grip of the hook portion 135 on the bike always pulls tight to the tire. Additionally, the constant downward force of the spring or elastomer 170 allows for a comfortable extension of the hook arm 130 because the force to extend the hook arm 130 remains the same regardless of how far the spring or elastomer is extended. Further the spring or elastomer 170 does not oscillate like an extension spring or rubber band would, and thus the mechanism extends and contracts quietly.

Another benefit of the hook arm of the present carrier system 100 is that it maximizes bike wheel fit range. Specifically, the design of the hook arm and mechanical locking mechanism 155 allows the carrier 100 to keep maximum wheel fit range because the retraction mechanism 155 is on the far side of the hook arm 130 (opposite the side of the axle 125), which allows the inner adjustable arm 150 to collapse as close to the pivot axle 125 as possible.

In one or more embodiments, the hook portion 135 can be sized and shaped to fit along the edge of the distal end of the first support member 110. For example, in one or more embodiments as exemplified in FIG. 1A, the distal end of the first support member 110 can include a groove or catching feature 177 into which the distal end of the hook arm fits to prevent the hook arm from moving when the hook arm is in a storage position. This catching feature or groove 177 on distal end of the first support member 110 prevents the hook arm 130 from rotating into the back of the vehicle when the carrier 100 is in a storage position (i.e., when the carrier is folded in a vertical position and no bicycle is loaded on to the carrier). In at least one embodiment, instead of grooves, the distal end of the hook arm can be captured alongside the distal end of the first support member 110 via friction when the hook arm is in a storage position.

As exemplified in FIG. 1D, in one or more embodiments, the hook arm 130 is attached to the support member (e.g., first support member 110) that is configured to hold the front wheel of the bicycle. However, in at least one embodiment, the hook arm 130 can be attached to the support member (e.g., second support member 120) that is configured to hold the back wheel of the bicycle.

In one or more embodiments, as exemplified in FIG. 1D, the carrier system 100 further comprises an upper stop 180 located on or about the first support member 110. The upper stop 180 is configured to prevent upward rotation of the hook arm 130 about the pivot axel 125 past a predetermined angle relative to horizontal. Thus, the upper stop 180 can prevent the hook from contacting a frame or fork, fenders, or rack of the bicycle when loaded into the carrier 100. More specifically, in one or more embodiments, the upper stop 180 can stop the rotation of the hook arm 130 at a specific predetermined angle relative to the horizontal, which allows the hook portion 135 to contact the tire in an orientation that requires extension of the adjustable arm 150, but does not contact the frame or fork of the bicycle when any of the compatible wheel sizes are used. The location of the upper stop 180 also maximizes fender clearance. For example, in one or more embodiments, the predetermined angle is between approximately 45° and approximately 75° relative to horizontal. In at least one embodiment, the predetermined angle is approximately 52° relative to horizontal.

In one or more embodiments, the upper stop 180 prevents the hook portion 135 from contacting the frame or fork of the bicycle (or braking and shifting cables of the bicycle) when the hook portion 135 is in the engaged position, and is positioned so that the when the hook portion 135 is engaged with the tire of the bicycle, the adjustable arm 150 would have to extend outwardly to disengage the hook portion 135 from the tire in order to rotate or pivot the down hook arm 130 down to a storage position. In other words, because interference between the tire and hook increases as the arm rotates down, the hook portion 135 is prevented from falling down and releasing when it is in contact with the tire, even without a mechanical lock in the upward position.

As such, when the hook arm 130 is in the wheel mounting position (i.e., when the hook arm 130 is located at the upper stop 180), the hook portion 135 is as far forward as possible on all common wheel sizes (e.g., 20” through 29’ and 650 x 5” tires) while still being positioned such that interference between the tire and the hook portion 135 increases when the hook arm 130 rotates down. In one or more embodiments, the upper stop 180 is also positioned to avoid contact between the hook arm 130 and the front fender of the bicycle, while still maintaining increased interference as the hook arm 130 rotates downwardly.

In one or more embodiments, the carrier system 100 further includes a lower stop 185 located on or about the first support member 110 and configured to prevent downward rotation of the hook arm about the pivot axel 125 past approximately 0 degrees relative to horizontal. The lower stop 185 is a rotational limit on the movement of the hook arm 130, and keeps the hook arm 130 from rotating too far downwards and hitting the ground. In one or more embodiments, when the hook arm 130 rotates to the lower stop 185, the hook portion 135 of the hook arm 130 aligns with the first support member 110, and this positioning allows the hook portion 135 to rest on the first support member 110 or in the groove or catching feature 177.

FIGS. 1F-1I display diagrams of the adjustable hook arm in a use position displaying the upper stop 180 (FIG. 1F)/ 180A (FIG. 1H), and in a storage position displaying the lower stop 185 (FIG. 1G)/ 185A (FIG. 1I) in accordance with one or more embodiments.

Conventional bicycle racks do not feature an upper stop position for a hook arm. This can create a situation where a hook arm contacts the frame or fork of the bike causing damage to the bike. In some instances, the lack of an upper stop in conventional racks can cause a hook arm to be used incorrectly by the customer, creating an insecure bike attachment. The upper stop 180 of the present carrier 100 solves those issues by preventing contact between the hook arm and the frame of the bicycle, and by creating a secure connection between the hook arm and the tire due to the spring or elastomer 170 and the positioning of the hook portion 135 on the bicycle tire.

The upper stop 180 and lower stop 185 also provide other advantages over conventional racks. For example, the upper stop 180 provides the customer with a clearly defined upper position for the hook arm 130, so the user does not have to guess where to mount the hook arm on the bicycle tire. Thus, this feature minimizes the chances that a customer places the hook arm 130 at an incorrect location on the tire that would allow the bike to be insecure on the rack. Additionally, because the upper stop 180 prevents contact between the hook arm 130 and a fender of the bicycle, the carrier system 100 is fender compatible. More specifically, bike fenders are generally not able to support the forces applied by a conventional hook arm, and are similarly not strong enough to act as locating features for the hook. By positioning the hook portion 135 in front of the fender of the bike, the carrier system 100 can accommodate bikes that have front wheel fenders which extend in front of the fork.

The upper stop 180 also ensures that the bike wheel is held more securely than conventional racks. Specifically, the upper stop 180 minimizes the amount that the bike can roll rearward once the hook is tightened, which provides a more secure retention of the bike than conventional rack systems that rely on fork or frame contact.

In one or more embodiments, the position of the upper stop 180/180A can be more clearly indicated by a detent or snap feature 190 that biases the hook arm 130 to the upper or lower positions and makes it more difficult to place it in an intermediate position. The detent snap feature 190 can be used to position the arm into discrete rotational positions that constrain the arm to a specific and/or predetermined angle. Alternatively, in at least one embodiment, the hook arm can include a mechanical lock, such as a pin, to fix it in upper and/or lower positions (e.g., at the upper stop 180 or lower stop 185).

Finally, it should be understood that while FIGS. 1A-1G display embodiments of system 100 configured for holding two bicycles, in certain embodiments, the system can be configured to only hold one bicycle (e.g., only include a support member for supporting each of the front tire and the rear tire of a single bicycle, or single support member, such as a tray, for support both tires of the single bicycle). Likewise, in certain embodiments, the system can be configured to include additional support members such and corresponding hook arms such that the system can hold 3, 4, 5, or 6 bicycles, for example.

### Bike Interference Adjustment Device

In a second aspect, the present application relates to a carrier system that includes a bike interference adjustment device. When transporting multiple bikes on a vehicle, a common concern is avoiding interference between bikes or interference between the bike and the vehicle. Interference can cause damage to bikes as well as the vehicle, and may lead customers to mount bikes incorrectly on the rack. One of the most common interferences on tray-style hitch racks, for example, is between the handlebars of one bike and the seat or wheel or frame of the next nearest bike position. Previous solutions to these issues have mainly focused on allowing bikes to be moved horizontally relative to one another. In contrast, the bike interference adjustment device of the present application can address bike interference between the bike and the vehicle and/or between multiple bikes by moving a wheel of at least one bike vertically relative to aspects of the vehicle and/or relative to an adjacent bike on the bike rack.

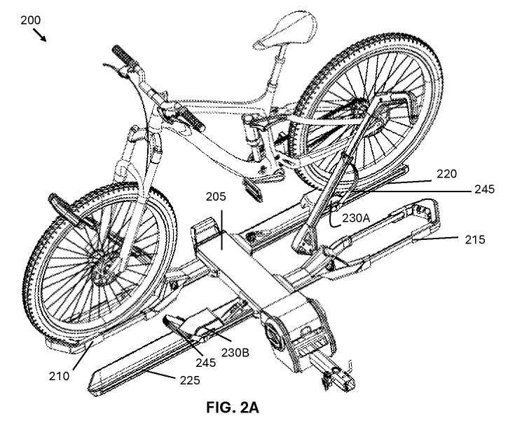

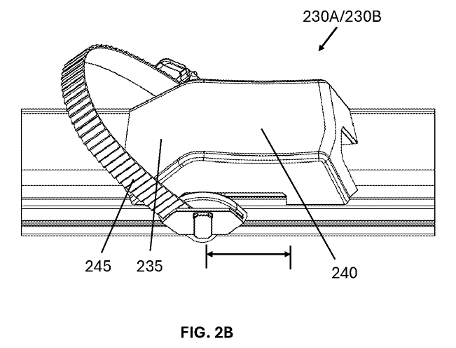

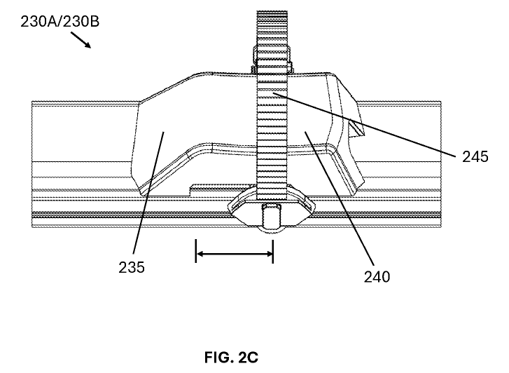

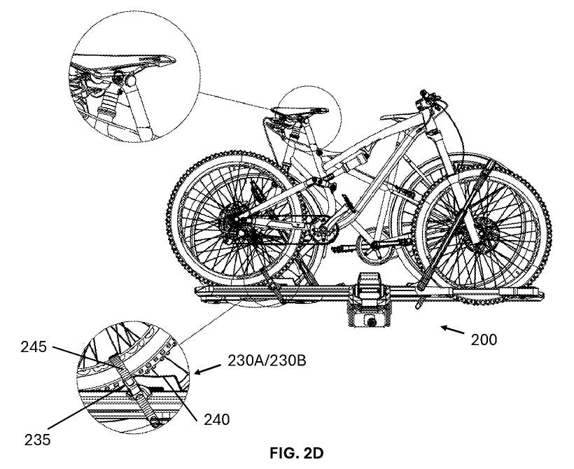

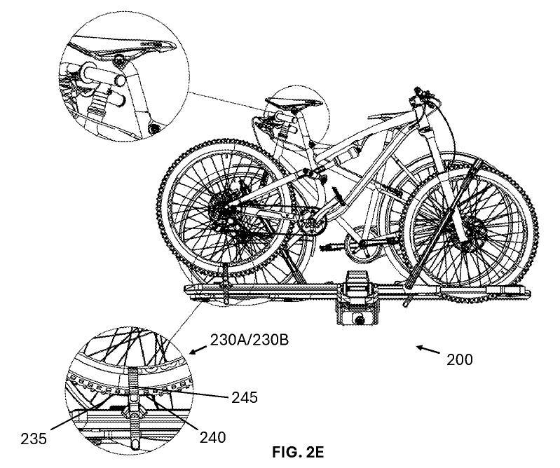

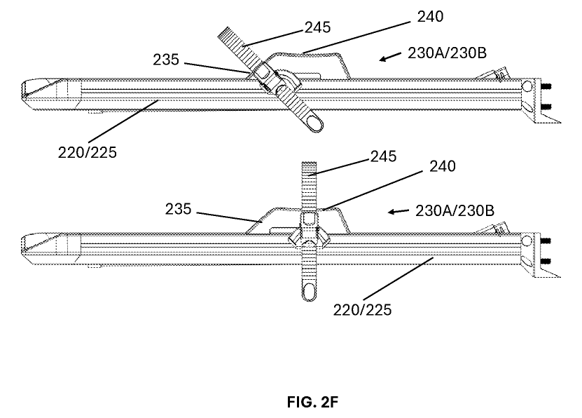

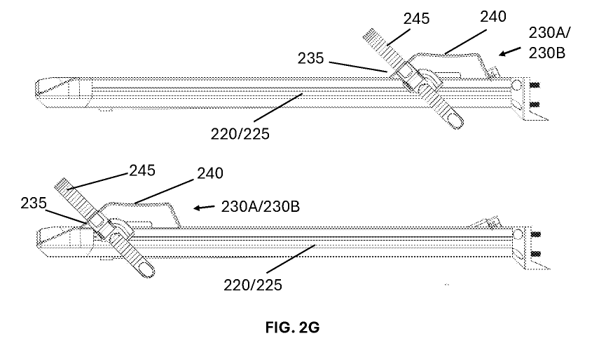

FIGS. 2A-2G show aspects of a carrier system that includes at least one bike interference adjustment device in accordance with one or more embodiments. As exemplified in FIGS. 2A-2G, in one or more embodiments, the carrier system 200 including the bike interference adjustment device can include a base 205 configured to attach to a motor vehicle, and a first tire support member 210 and a second tire support member 220, each configured to support one of the tires of a first bicycle. The system 200 also includes a third tire support member 215 and a fourth tire support member 225, each configured to support one of the tires of a second bicycle.

In one or more embodiments, the first and third tire support members are configured to support the front tires of the first and second bicycles, respectively, and the second and fourth tire support members are configured to support rear tires of the first and second bicycles, respectively. In at least one embodiment, the first and third tire support members are configured to support the respective rear tires of the two bicycles and the second and fourth support members are configured to support the respective front tires of the two bicycles. Although, it should be understood that, in at least one embodiment, the first and fourth support members can be used to support either the front or rear wheels of the respective bicycles. In one or more embodiments, the one or more tire support members (e.g., 210-225) can be in the form of a tray, multiple trays, a single platform, or multiple platforms, for example. Thus, for example, in certain embodiments, the instead of first and second tire support members supporting the respective tires of a single bicycle, a single tray can support both tires of a bicycle. Likewise, in at least one embodiment, the tires of multiple bicycles can be supported by a single tray or platform.

Each of the tire support members 210-225 are configured to securely hold in place a of the first or second bicycle, respectively. As exemplified in the figures(e.g. FIGS. 2D-2E), in one or more embodiments, the carrier system 200 is configured such that the first bicycle faces the opposite direction relative to the second bicycle when both bicycles are loaded into the carrier 200.

The carrier system 200 also include a first interference adjustment device 230A and a second interference adjustment device 230B. In one or more embodiments, the first and second interference adjustment devices 230A and 230B are located on the tire support members 220 and 225 respectively. The first and second interference adjustment devices 230A and 230B are configured to raise and lower the respective tires of the first and second bicycles to discrete positions. The raising or lowering of the respective tires allows the interference adjustment mechanisms to eliminate interference between the first and second bikes.

For example, in one or more embodiments when the first bicycle and second bicycle are arranged in the rack such that front tire of the first bike and the front tire of the second bike face in opposite directions, raising or lowering of one or both of the respective back tires can eliminate interference between the handlebars of the first bicycle and the seat, tire, and/or accessories of the second bicycle, and vice versa.

As exemplified in FIGS. 2B and 2C, in one or more embodiments, the first and second interference adjustment devices 230A, 230B each include a first surface 235 at a proximal end of the interference adjustment device 230A/230B. The first surface 235 is a non-horizontal surface located above a surface of the respective tire support member 220/225. The interference adjustment devices 230A/230B further include a second surface 240 located adjacent to the first surface 235 and at a distal end of the interference adjustment device 230A/240B. The second surface 240 a generally horizontal surface having an elevated position above the first surface 235.

In such embodiments, when the tires of the respective first and second bicycles are loaded into the carrier 200 adjacent to interference adjustment devices 230A/230B, the respective tire is configured to rest on either the first surface 235 or the second surface 240 of the respective interference adjustment devices 230A/230B to avoid interference between (e.g., contact between) the first and second bicycles. Specifically, in one or more embodiments, upon placement of the tire of the respective first and second bikes on the first and second interference adjustment devices 230A and 230B, the first and second interference adjustment devices 230A and 230B are configured to raise the tires of the first and second bicycles relative to the adjacent tires of the other bicycle and thereby eliminate interference (e.g., contact) between aspects of the first and second bicycles (e.g., seat of the first bike and the handlebars of the second bike, and vice versa).

For example, as exemplified in FIG. 2D, sometimes when the two bicycles are loaded into the carrier 200, the seat of the first bicycle can interfere (make contact with) the handlebars or another portion of the second bicycle. To prevent this type of contact between the first bicycle and the second bicycle, which can cause damage to one or both of the bicycles, the back tire of the first bicycle can be positioned on the second surface 240 of interference adjustment device 230A, as exemplified in FIG. 2E, thereby lifting the back end of the first bicycle upward such that the seat of the first bicycle is above the handlebars of the second bicycle. In other instances, when placement of the back tire on the second surface 240 results interference with an adjacent bicycle, moving the back tire of the bicycle down to rest on the first surface 235 can eliminate the interference between the two bicycles.

In one or more embodiments, the interference adjustment devices are configured to adjust the height of the respective rear wheels of the first and second bikes without translating the front axle of the respective first and second bikes horizontally.

In one or more embodiments, each interference adjustment device 230A/230B can also include a strap 245 configured to wrap around the tire of the respective bicycle. In one or more embodiments, the strap 245 can comprise an adjustable ratchet mechanism configured to accommodate wheels of different sizes. The strap 245 can attach on the outside of the tire support member 220/225 and/or the interference adjustment device 230A/230B. In one or more embodiments, the strap is slidably connected to the tire support member 220/225 and/or the interference adjustment device 230A/230B, and the location of the strap is adjustable along the length of the respective interference adjustment device as shown in FIG. 2F. For example, if the tire of the bicycle is placed on the first surface 235, the strap 245 can be positioned near a proximal end of the interference adjustment device 230A/230B as exemplified in FIG. 2A. Likewise, if the tire of the bicycle is placed on the second surface 240, the strap 245 can moved distally (e.g. via a track) such that it is positioned near a distal end of the interference adjustment device 230A/230B as exemplified in FIG. 2F. In one or more embodiments, the strap 245 rotatable on the carrier system 200.

In one or more embodiments, the locations of the first and second interference adjustment devices 230A and 230B are adjustable along the length of the tire support members 220 and 225, respectively (e.g. via a track) as exemplified in FIG. 2G. Adjustment of the location of the interference adjustment device 230A/230B allows the carrier 200 to accommodate bicycles of different sizes, while still allowing for vertical adjustment of the location of the rear wheel by way of the interference adjustment device 230A/230B to avoid interference between adjacent bicycles. In such embodiments, the strap 245 is operatively connected to the interference adjustment device 230A/230B and thus can move in concert with the interference adjustment device 230A/230B.

In one or more embodiments, the bike interference adjustment device 230A/230B can also be implemented on the carrier system 100 of FIGS. 1A-1E, for example on the second support member 115 of carrier system 100.

While FIGS. 2A-2G illustrate embodiments of a carrier system 200 that is configured to carry two bicycles and in which each tire of each bicycle is located on a separate tire support member, in certain embodiments, both tires of a bicycle can be located on a single tire support member, such as a tray or platform, for example, and at least one bike interference adjustment device 230A/230B can be located on each tire support member.

For example, in a single bicycle embodiment, the carrier system (200 or 100) can include a base configured to attach to a motor vehicle a support member attached to the base, wherein the tire support member is configured to support the tires of at least one bicycle. The system can further include at least one interference adjustment device located on the tire support member, such that the at least one interference adjustment device is configured to raise and lower a tire of the bicycle located on the tire support member. As such, in this single bicycle embodiment, the at least one interference adjustment device is configured to adjust the height of a tire of the bicycle to avoid interference with the vehicle.

In at least one embodiment, the carrier system 200 (or 100) can comprises additional support members and additional corresponding bike interference adjustment devices such that the carrier system is configured to avoid interference between 2, 3, 4, 5, or 6 bicycles held by the system, for example.

### Hitch Tightening Mechanism

In a third aspect, the present application discloses a carrier system including a hitch tightening mechanism configured for attachment to the hitch receiver of a motor vehicle. The hitch tightening mechanism is configured to tighten the connection of the carrier to the hitch receiver both vertically and horizontally to fully constrain the tube of the carrier system in the hitch receiver to prevent movement. Specifically, the hitch tightening mechanism used a cam that rotates outside of the tube of the carrier system to deliver increased leverage and better tighten into the hitch receiver of the vehicle. In one or more embodiments, the hitch tightening mechanism does not require the use of a separate tool to tighten the connection of the carrier to the hitch receiver. The vertical and horizontal tightening of the present hitch tightening mechanism is in contrast with many conventional mechanisms that only tighten in one plane (vertical or horizontal), and thus allow movement in the other plane.

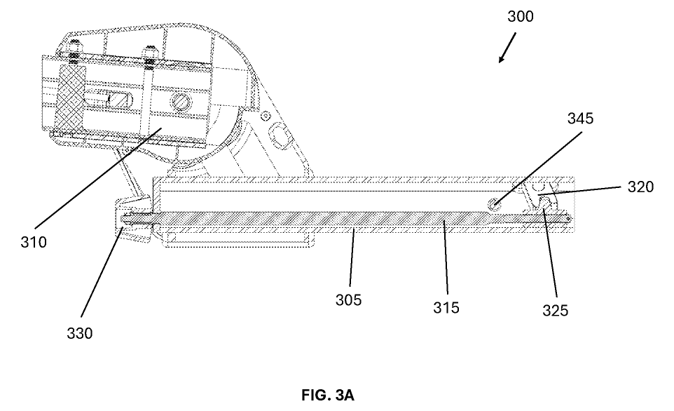

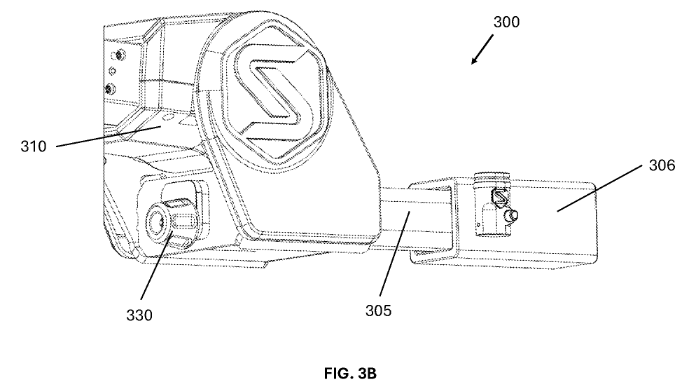

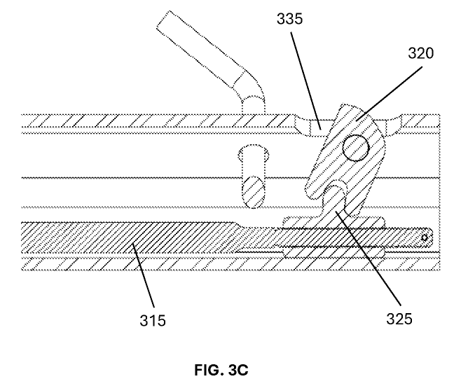

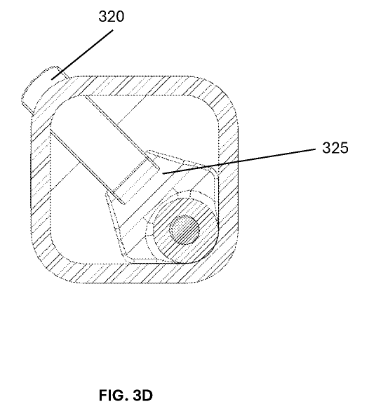

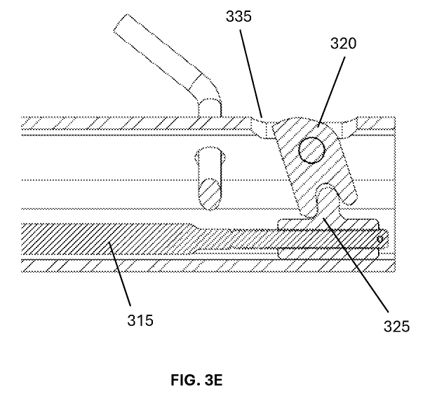

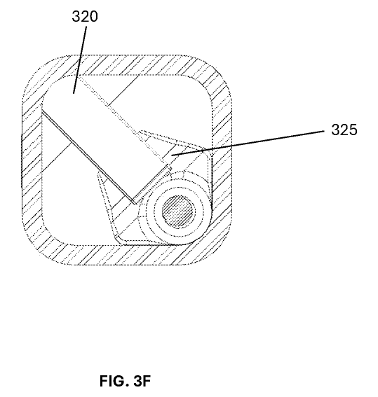

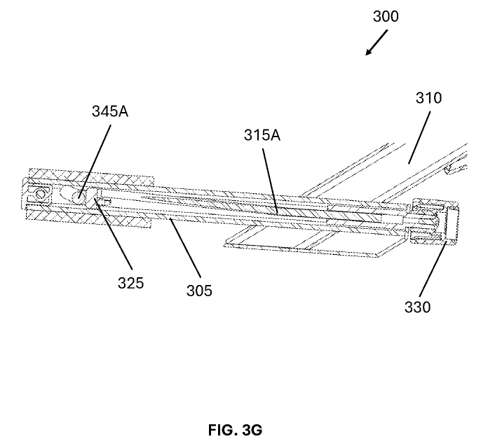

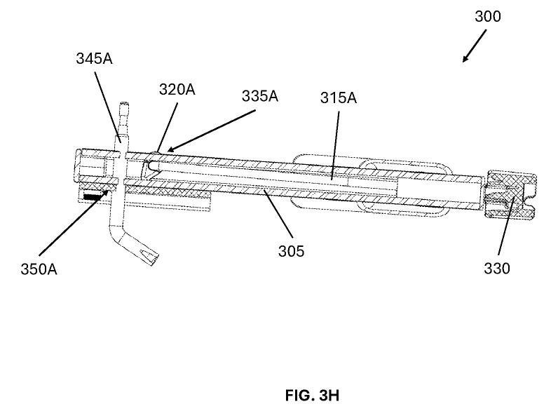

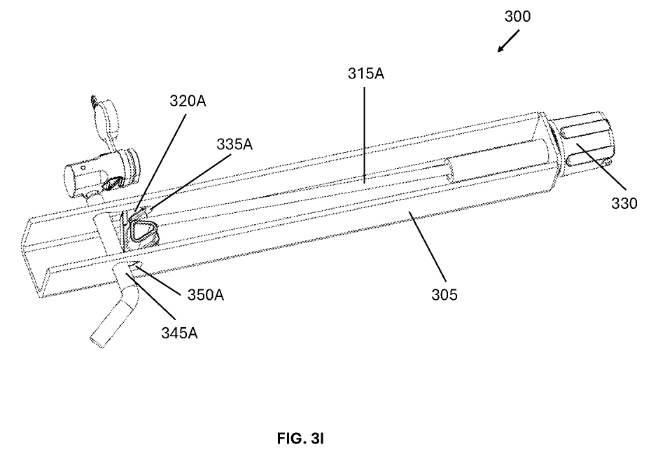

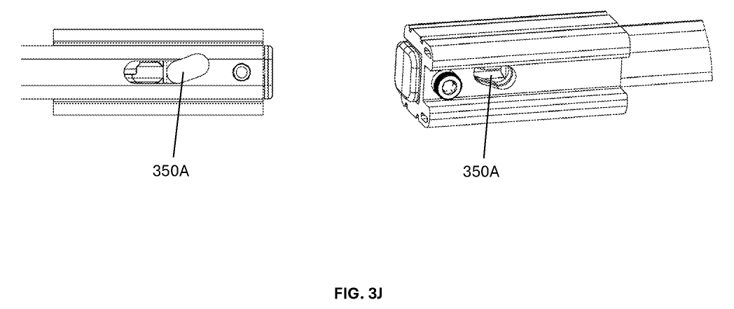

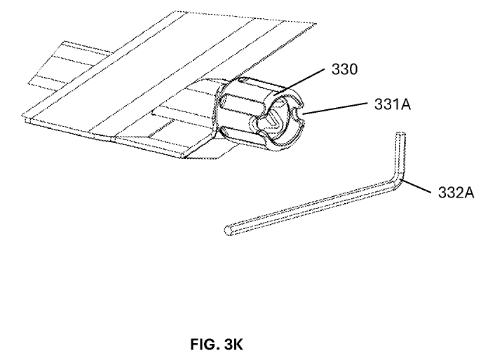

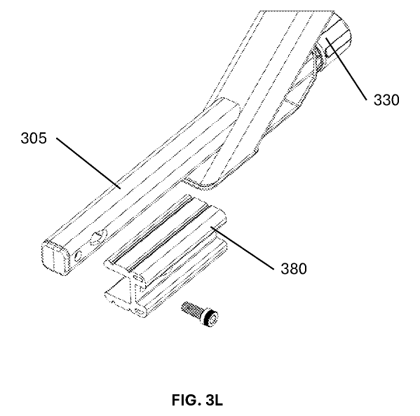

A first embodiment of the hitch tightening mechanism for a bike carrier system is exemplified in FIGS. 3A-3F. With reference now to FIGS. 3A-3F, a hitch tightening mechanism 300 is shown that includes a stinger tube 305 connected to a base 310 of the bike carrier system. The stinger tube 305 is configured for placement within a hitch receiver 306 of a motor vehicle at a proximal end of the stinger tube 305. As used herein, “stinger tube” refers to the tube extending from the bike carrier system that penetrates the vehicle’s hitch receiver and forms a key interface between the carrier system and the vehicle. The mechanism 300 also includes a linkage 315 (for example, a rod) located within the stinger tube 305. In one or more embodiments, the rod is a threaded rod. The mechanism 300 further includes a cam 320 and a cam follower 325. The cam 320 and cam follower 325 are operatively connected to one another and located within the stinger tube 305. In one or more embodiments, the linkage 315 is connected to (e.g., threaded into) the cam follower 325 at a proximal end of the linkage 315. However, it should be understood that in other embodiments, the cam follower 325 can be attached to one or more different points on the linkage 315. The mechanism 300 further includes a drive end 330 (e.g., knob, handle, or tool interface) located at a distal end of the stinger tube 305. The linkage 315 is connected to (e.g., threaded into and secured with a fixed nut) the drive end 330 at a distal end of the linkage 315. The stinger tube 305 also includes an aperture 335 on the stinger tube 305 and adjacent to the cam 320. In at least one implementation, the aperture 335 is located on an upper portion and/or side portion of the stinger tube 305 above the cam 320.

To tighten the connection of the stinger tube 305 within the hitch receiver of the motor vehicle, the drive end 330 is configured to rotate causing the linkage 315 to rotate (e.g., be driven into) the cam follower 325 (for example, in a proximal direction), and thereby rotating a top end of the cam 320 to a location outside the aperture 335 of the stinger tube 305 where the cam 320 engages with (i.e. contacts) the inside of the hitch receiver. Specifically, the cam 320 presses into the inner corner of the hitch receiver tube of the vehicle which drives the stinger tube 305 to the opposing corner of the hitch receiver tube. As shown on FIG. 3A, the cam is constrained on its axis and constrained within the aperture 335.

In one or more embodiments, the cam follower 325 and linkage 315 are threaded, as exemplified in FIG. 3A. As such, the cam 320 is rotated by the threaded cam follower 325, which is driven by a threaded rod 315 attached to a drive end 330 at the end of the stinger tube 305. As exemplified in this embodiment, the cam 320 is rotating on an angled axis which allows it to provide force in the vertical and horizontal plane, eliminating unwanted movement of the stinger tube 305 in these planes. This configuration of the cam 320 and the cam follower 325 allows the user to easily tighten the stinger tube by hand using the drive end 330 at the end of the stinger tube 305.

In one or more embodiments, the drive end 330 can be rotated by a user without the use of a separate tool. In at least one embodiment, as exemplified in FIG. 3K, the drive end 330 can include one or more indentations 331 at its distal end configured to accommodate a tool for further tightening of the mechanism. Specifically, a tool can be used to engage the one or more indentations 331 such that the user can utilizes a greater amount of torque to rotate of the drive end, thereby resulting in further tightening of the connection of the stinger tube 305 within the hitch receiver. In one or more embodiments, the tool can be a hex key 332 or other tools such as a screwdriver, or a straight edged tool, for example.

With specific reference to FIG. 3C, when the cam 320 is rotated out through the aperture 335, the cam 320 can contact or interfere with an inner corner of the hitch receiver of the vehicle, such that the stinger tube 305 is secured within the hitch receiver (i.e., the “tight” position). As exemplified in FIG. 3C, in one or more embodiments the rod 315 can be threaded through the cam follower 325 in order to rotate the cam 320 through the aperture 335. FIG. 3D shows an end view of the cam 320 in the “tight” position, showing the cam 320 rotated out of the aperture 335.

As shown in FIG. 3E, when the cam 320 is rotated back below the level of the aperture 335 within the stinger tube 305, the stinger tube 305 can be freely inserted and removed from the hitch receiver (i.e., the “loose” position). As exemplified in FIG. 3E, in one or more embodiments the cam follower 325 can be threaded in the distal direction (in the direction of the vehicle) in order to rotate the cam 320 back down below the level of the aperture 355. FIG. 3F shows an end view of the cam 320 in the “loose” position, showing the cam 320 rotated back within the stinger tube 305.

In one or more embodiments, the mechanism 300 further includes a pin 345 inserted within an opening 350 in the stinger tube 305. In one or more embodiments, the opening 350 is adjacent to the aperture 335. In one or more embodiments, the pin 345 includes a predominantly straight portion 355 that is inserted within the opening 350 and a bent portion 360 located outside of the stinger tube 305. The pin 355 is configured to prevent the stinger tube 305 from disconnecting from the hitch receiver when a top end of the cam 320 is rotated outside of the aperture 335A. In this embodiment, pin 345 is not involved in the tightening of this embodiment but is provided for a secondary safety feature as well as a security measure for the rack. In one or more embodiments, the cam 320 is constrained by a cam pin 365, which is pressed into the stinger tube 305 as well as a slot cut near the corner of the stinger tube 305.

In one or more embodiments, as exemplified in FIG. 3G, the opening 350A is distal to the aperture 335B, and the pin 345 acts as a secondary safety mechanism to prevent dislodgment of the stinger tube 305 from the hitch receiver after insertion.

FIGS. 3G-3J show a second embodiment of the hitch tightening mechanism 300, in which the linkage 315A is a bent rod. The bent rod 315A can also be operatively connected to a long nut 370 which is configured to drive the threaded rod 315A in compression. As exemplified in FIG. 3H, the cam 320A, which can be generally wedge-shaped, is pushed by the bent rod 315A such that the cam 320A presses against a hitch pin 345A, which is fixed in place by the hole in the receiver. The force of the cam 320A force on the pin forces the rack to slide forward and press the ramp against the pin, tightening the rack vertically. The cam 320A simultaneously rotates outward against the side of the receiver, tightening horizontally. The cam 320A is designed to account for the variance in hitch receiver internal dimensions. Specifically, as exemplified in FIG. 3H, the bent pin 345A can be configured to pass through a cut-out opening 350A in the stinger tube 305. The cutout opening 350A on one side is larger to allow for the movement of the cam upon contact with the pin 345A. The larger cutout opening 350A includes an upwardly tilted portion or ramp 375. The ramp 375 is designed to provide adequate tightening, and still account for the variance in receiver internal dimensions. In one or more embodiments, the ramp is approximately 15-20 degrees relative to horizontal.

As exemplified in FIGS. 3H-3I, the opening 350A is proximate to the aperture 335, and as the top end of the cam 320A rotates to a location outside of the aperture 335, a bottom end of the cam 320A presses against a portion of the pin 345A within the stinger tube 305 causing the pin 345A to move proximally within the opening, thereby vertically tightening the connection of the stinger tube 305 with the hitch receiver.

The bend in the rod 315A (e.g., a threaded rod) helps to prevent wear and tear on the rod through multiple uses of the mechanism 300. Specifically, the bend in the rod 315A generates flex, allowing the system to stay tight even as parts wear or vibrate in use. In one or more embodiments, a left-hand thread is used on the rod 315A and long nut 370 to ensure the action of tightening is an intuitive clockwise turn of the drive end 330. In one or more embodiments, the drive end 330 has a feature in the end that allows the use of a tool to increase the tightening torque if desired. For example, the tool can be a hex key handle, a screwdriver or any other straight edged tool to be used to increase available torque.

The stinger tube 305 is sized and shaped to be inserted into the hitch receiver of a vehicle. For example, in one or more embodiments, the stinger tube 305 can be sized and shaped to fit within a 1.25-inch square receiver. In one or more embodiments, the stinger tube 305 can be sized and shaped to fit within a 2-inch square receiver. In at least one embodiment, the mechanism 300 can further include an adapter sleeve 380, as exemplified in FIG. 3L, that is removably attachable to a proximal end the stinger tube 305 to enable the stinger tuber 305 to be securely inserted into larger sized hitch receivers. It should be understood that, in one or more embodiments, the stinger tube 305 can be sized and shaped either alone or in combination with the adapter sleeve 380 to be securely received within any standard sized hitch receiver.

The hitch tightening mechanism of the present application provides many benefits and improvements relative to conventional hitch attachment mechanisms. Specifically, the movement of the cam allows for better tuning of the tightening action. Additionally, faster initial movement of the cam (via turning of the drive end) can occur to allow for easy and quick assembly and disassembly. Further, in certain embodiments, greater torque can be utilized (e.g., via use of a tool) to maximize how tight the mechanism becomes in the hitch receiver. This allows the system to achieve high tightening force while still engaging and disengaging quickly.

Further, in embodiments with the bent rod and the bent pin, the larger bent pin cutout 350A gives the user a bigger target for installing the pin, and does not require that the rack be perfectly aligned with the hitch receiver to get the pin installed.

Additionally, in one or more embodiments, the pin in the present hitch tightening mechanism is held tight in use, so it will not rattle when driving. The pin is an integral part of the system, so even if a customer does not tighten the rack or the system becomes loose which the vehicle is travelling and connected to the bike rack, the stinger tube of the bike rack will still be fully retained in the hitch. Finally, because the openings/apertures in the stinger tube are all supported within the hitch receiver, the cam can be used with a smaller hitch receiver tube (e.g., 1.25” tube) instead of needing a solid bar. This helps to keep the weight of the bike rack low, making installation and removal of the bike rack on the vehicle easier.

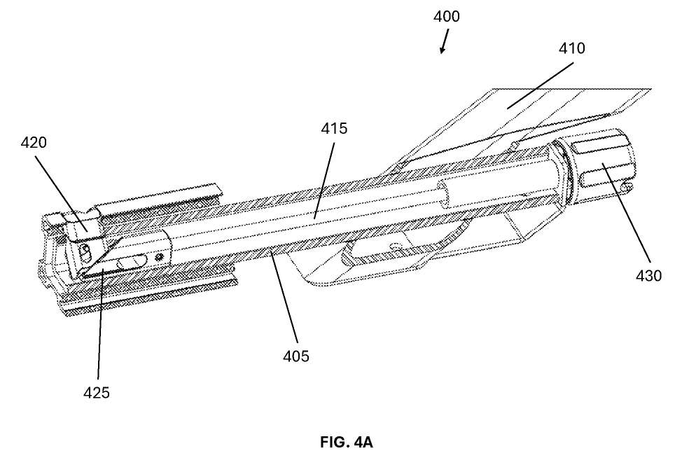

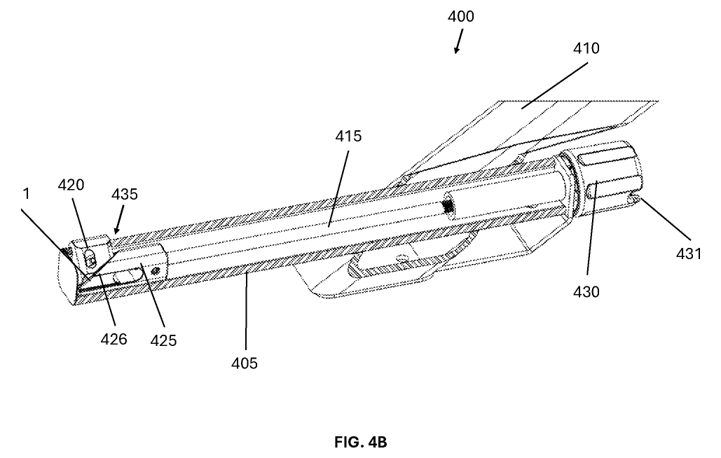

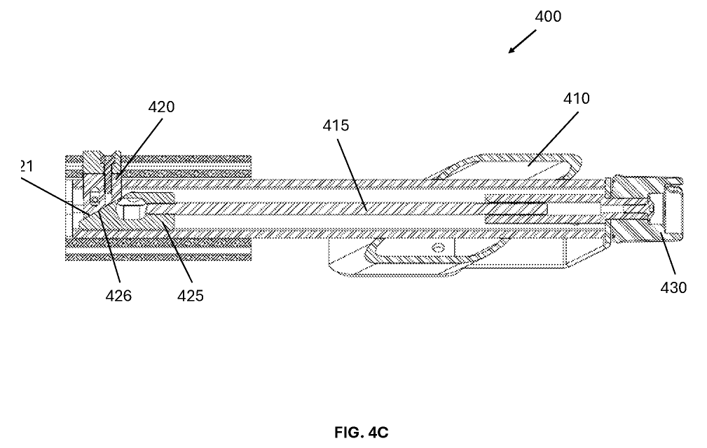

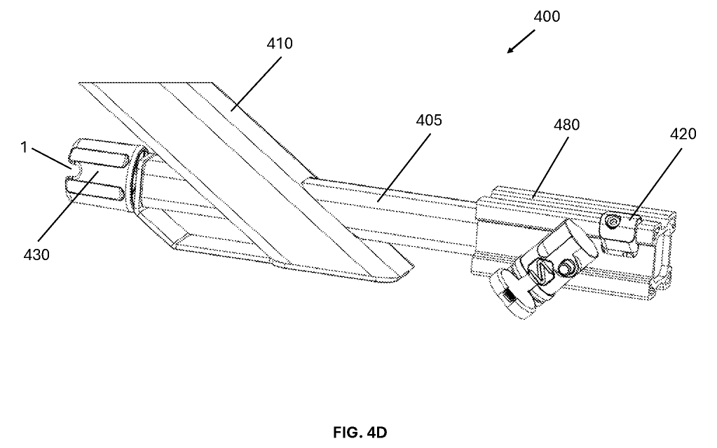

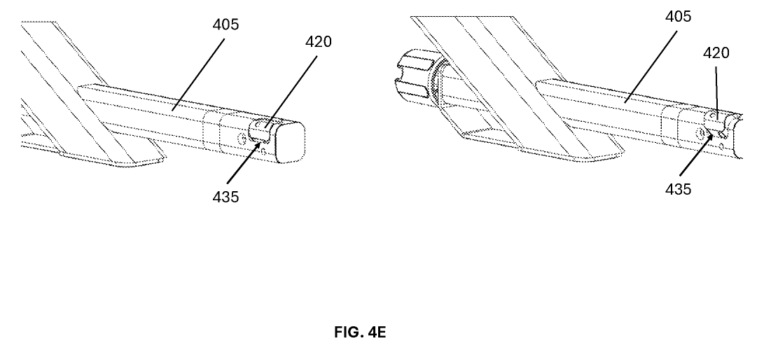

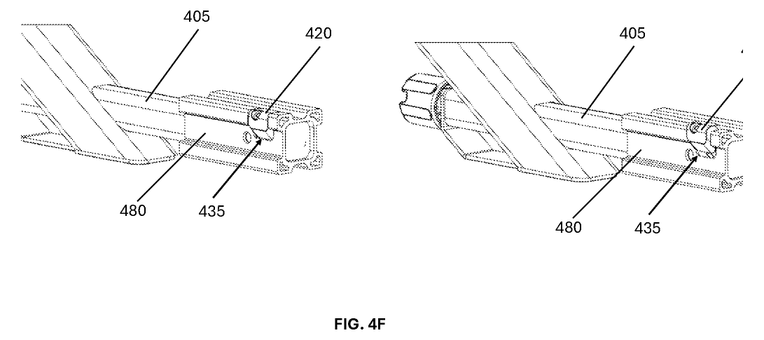

A third embodiment of the hitch tightening mechanism for a bike carrier system is exemplified in FIGS. 4A-4F. With reference now to FIGS. 4A-4F, a hitch tightening mechanism 400 is shown that includes a stinger tube 405 connected to a base 410 of a bike carrier system. The mechanism 400 also includes a linkage (e.g., rod) 415 located within the stinger tube 405. In one or more embodiments, the rod is a threaded rod at a distal end. The mechanism 400 further includes a wedge block 420 and an actuator 425. The wedge block 420 and actuator 425 are adjacent to one another and located within the stinger tube 405. In one or more embodiment, the wedge block 420 and/or the actuator 425 can be operatively connected to the stinger tube 405 (e.g., via a pin). In one or more embodiments, the linkage 415 is connected to the actuator 425 at a proximal end of the linkage 415. However, it should be understood that in other embodiments, the actuator 425 can be attached to one or more different points on the linkage 415. The mechanism 400 further includes a drive end 430 (e.g., knob, handle, or tool interface) located at a distal end of the stinger tube 405. The linkage 415 is connected to or threaded into the drive end 430 at a distal end of the linkage 415. The stinger tube 405 also includes an aperture 435 on the stinger tube 405 adjacent to the wedge block 420. In at least one implementation, the aperture 434 is located on an upper portion and/or side portion of the stinger tube 405 above the wedge block 420.

To tighten the connection of the stinger tube 405 within the hitch receiver of the motor vehicle, the drive end 430 is configured to rotate causing the linkage 415 to drive the actuator 425 (for example, in a proximal direction) into the wedge block, and thereby pushing a top end of the wedge block 420 to a location outside the aperture 435 of the stinger tube 405 where the wedge block 420 engages with (i.e. contacts) the inside of the hitch receiver. In one or more embodiments, the wedge block 420 presses into the inner corner of the hitch receiver tube of the vehicle which drives the stinger tube 405 to the opposing corner of the hitch receiver tube.

As exemplified in FIGS. 4B-4C, in one or more embodiments, the wedge block 420 and the actuator 425 can have opposing angled (e.g., non-horizontal) faces 421 and 426, respectively. In such embodiments, when the drive end 430 is rotated, the linkage 415 drives opposing face 426 into opposing face 421, and thereby pushing a top end of the wedge block 420 to a location outside the aperture 435 of the stinger tube 405 where the wedge block 420 engages with the inside of the hitch receiver.

In one or more embodiments, the wedge block 420 actuates outward at approximately a 45-degree angle to tighten into the opposite two walls of the receiver tube, thus constraining the stinger tube 405 both horizontally and vertically.

In one or more embodiments, the stinger tube is configured to be received by a hitch receiver or receiver tube that is not square-shaped. In such embodiments, the wedge block 420 and the apertures 435 can have sufficient clearance to allow the wedge block to automatically tightening the hitch tightening mechanism in both horizontal and vertical orientations.

In one or more embodiments, the drive end 430 can be rotated by a user with or without the use of a separate tool. In embodiments in which a tool is used for rotating the drive end 430, as exemplified in FIG. 4B, the drive end 430 can include one or more indentations 431 at its distal end configured to accommodate a tool for further tightening of the mechanism. Specifically, a tool can be used to engage the one or more indentations 431 such that the user can utilizes a greater amount of torque to rotate of the drive end, thereby resulting in further tightening of the connection of the stinger tube 405 within the hitch receiver. In one or more embodiments, the tool can be a hex key or other tools such as a screwdriver, or a straight edged tool, for example. Alternatively, in other embodiments, the drive end 430 can include one or more notches or holds at its distal end for use with or without a tool to aid in tightening the mechanism. The stinger tube 405 is sized and shaped to be inserted into the hitch receiver of a vehicle. For example, in one or more embodiments, the stinger tube 405 can be sized and shaped to fit within a 1.25-inch square receiver. In one or more embodiments, the stinger tube 405 can be sized and shaped to fit within a 2-inch square receiver. In at least one embodiment, the mechanism 400 can further include an adapter sleeve 480, as exemplified in FIG. 4D, that is removably attachable to a proximal end the stinger tube 405 to enable the stinger tuber 405 to be securely inserted into larger sized hitch receivers. FIG. 4E displays an exemplary mechanism 400 without the adapter sleeve for connection to smaller hitch receivers (e.g., 1.25-inch receivers), showing the mechanism 400 in the initial position and in the engaged or installed position in which the wedge block 420 is engaged with the receiver. Similarly, FIG. 4F displays an exemplary mechanism 400 with the adapter sleeve 480 for connection to larger hitch receivers (e.g., 2-inch receivers), showing the mechanism 400 in the initial position and in the engaged or installed position in which the wedge block 420 is engaged with the receiver.

It should be understood that, in one or more embodiments, the stinger tube 405 can be sized and shaped either alone or in combination with the adapter sleeve 480 to be securely received within any standard sized hitch receiver.

Finally, it is noted that the various embodiments of the adjustable hook arm, the interference adjustment device, and the hitch tightening mechanism features of the present application can be implemented together, or separately, in one or more bicycle carriers.

In accordance with one or more embodiments, exemplary embodiments of the adjustable hook arm, the interference adjustment device, and the hitch tightening mechanism features are set out in the following items:

Item 1. An adjustable arm bike carrier system, comprising:

a base configured to attach to a motor vehicle;

at least one support member attached to the base and configured to support the first and second tires of a bicycle;

a pivot axle; and

an adjustable hook arm operatively connected to the at least one support member or the base at the pivot axle, the hook arm being configured to rotate about the pivot axle in both directions and configured to securely hold the front or rear tire of the bicycle on the bike carrier system, the hook arm comprising:

an arm portion operatively connected to the pivot axle , and

a hook portion having a mechanical constraint, wherein the mechanical constraint causes the hook portion to compress the front or rear tire of the bicycle and is unidirectional to continually provide contact of the hook portion with the tire.

Item 2. The system of item 1, wherein the hook arm further comprises:

a trigger located on or attached to the hook arm;

wherein the hook portion is operatively connected to the trigger, and wherein upon activation of the trigger, the hook portion is configured to extend outwardly.

Item 3. The system of item 1, further comprising:

an upper stop located on or about the at least one support member and configured to prevent upward rotation of the hook arm about the pivot axle past a predetermined angle relative to horizontal, and

wherein the hook arm is positioned at an angle such that hook portion needs to extend away from the tire for the hook arm to rotate toward the at least one support member.

Item 4. The system of item 3, wherein the predetermined angle is between approximately 45° and approximately 75° relative to horizontal.

Item 5. The system of item 3, wherein the predetermined angle is approximately 52° relative to horizontal.

Item 6. The system of item 3, wherein the upper stop prevents the hook from contacting a frame or fork, fenders, or rack of the bicycle.

Item 7. The system of item 1, further comprising:

a lower stop located on or about the at least one support member and configured to prevent downward rotation of the hook arm about the pivot axle past approximately 0 degrees relative to horizontal.

Item 8. The system of item 1, further comprising:

a rotational constraint mechanism located on or about the at least one support member and configured to prevent rotation of the hook arm about the pivot axle away from a predetermined angle relative to horizontal.

Item 9. The system of item 1, wherein the arm portion comprises an outer tube operatively connected to the pivot axle, and an inner adjustable arm located within the outer tube, and wherein the mechanical constraint is located with the outer tube.

Item 10. The system of item 9, wherein the hook arm is operatively connected to a mechanical locking mechanism via a linkage, wherein upon activation of the trigger, at least a portion of the hook arm is configured to extend outwardly via the mechanical locking mechanism.

Item 11. The system of item 2, wherein the trigger is located at a proximal end of the hook portion.

Item 12. The system of item 10, wherein the mechanical locking mechanism is a ratchet mechanism.

Item 13. The system of item 12, wherein activation of the trigger causes the linkage to rotate a ratchet arm within the ratchet mechanism, such that the ratchet arm releases from the mechanism to allow the portion of the hook arm to extend.

Item 14. The system of item 1, wherein the mechanical constraint is a spring or an elastomer.

Item 15. The system of item 14, wherein the spring or elastomer is a constant force spring.

Item 15.1 The system of item 1, wherein the hook arm includes a spring or elastomer that bias the hook to the closest position relative to the pivot in addition to the mechanical constraint that causes the hook portion to compress the bicycle tire.

Item 15.2 The system of item 15.1, wherein the spring or elastomer is a constant force spring.

Item 16. An adjustable arm bike carrier system, comprising:

a base configured to attach to a motor vehicle;

a first support member attached to a first end of the base and configured to support a first tire of a bicycle;

a second support member attached to a second end of the base configured to support a second tire of a bicycle;

a pivot axle; and

a hook arm operatively connect to the first support member at the pivot axle, the hook arm being configured to rotate freely about the pivot axle in both directions and configured to securely hold the front or rear tire of the bicycle on the bike carrier system, the hook arm comprising:

a hook portion,

an arm portion having an outer tube operatively connected to the pivot axle, and an inner adjustable arm located within the outer tube, and

a constant force spring or elastomer located at a proximal end of the arm portion within the outer tube and operatively connected to the inner adjustable arm, wherein the constant force spring causes the hook portion to hold the front or rear tire of the bicycle.

Item 17. A carrier system comprising a bike interference adjustment device, the system comprising:

a base configured to attach to a motor vehicle;

at least one tire support member attached to the base, wherein the at least one tire support member is configured to support the tires of at least one bicycle;

at least one interference adjustment device located on the at least one tire support member, wherein the at least one interference adjustment device is configured to raise and lower a tire of the at least one bicycle located on the at least one tire support member.

Item 18. The carrier system of item 17, wherein the at least one interference adjustment device is configured to raise and lower the front or back tire of the at least one bicycle to different positions.

Item 19. The carrier system of item 17, wherein the location of the at least one interference adjustment device is adjustable along the length of the at least one tire support members.

Item 20. The carrier system of any one of items 17-19, further comprising:

a strap located adjacent to the at least one interference adjustment device wherein the strap is configured to wrap around the tire of the at least one bicycle.

Item 21. The carrier system of item 20, wherein the location of the strap is adjustable along the length of the at least one interference adjustment device.

Item 22. The carrier system of any one of items 17-21, wherein, the at least one tire support member comprises:

first and second tire support members attached to the base, wherein each of the first and second tire support members are configured to support one of the tires of a first bicycle,

third and fourth tire support members attached to the base, wherein each of the third and fourth tire support members are configured to support one of the tires of a second bicycle,

wherein the first tire support member is adjacent to fourth tire support member and the second tire support member is adjacent to the third tire support member,

wherein the at least one interference adjustment device comprises first and second interference adjustment devices located on the second and fourth tire support members, respectively, and

wherein upon placement of the respective tire of the first and second bicycles on the first and second interference adjustment devices, the first and second interference adjustment devices are configured to raise the respective tires of the first and second bicycles relative to the adjacent tires of the first and second bicycles located on the first and third tire support members and thereby eliminate interference between handlebars of the first and second bikes and seats of the first and second bikes.

Item 23. The carrier system of item 17, wherein the at least one interference adjustment device comprises:

a first surface at a proximal end of the interference adjustment device, the first surface being located above a surface of the at least one tire support member and,

a second surface adjacent to the first surface and at a distal end of the interference adjustment device, the second surface being located above the first surface, wherein the tire of the at least one bicycle is configured to rest on the first surface or the second surface of the interference adjustment device.

Item 24. The carrier system of item 23, wherein the first surface is a non-horizontal surface and the second surface is a generally horizontal surface.

Item 25. The carrier system of any one of item 24, wherein the at least one interference adjustment device is configured to adjust the height of the tires of the at least one bicycle without translating the front axle of the bicycle horizontally.

Item 26. A hitch tightening mechanism for a bike carrier system, comprising:

a stinger tube connected to a base of the bike carrier system, wherein the stinger tube is configured for placement within a hitch receiver of a motor vehicle at a proximal end of the stinger tube,

a linkage located within the stinger tube;

a cam and a cam follower operatively connected to one another and located within the stinger tube, wherein the linkage is connected to the cam follower at a proximal end of the linkage;

a drive end located at a distal end of the stinger tube, wherein the linkage is connected to the drive end at a distal end of the linkage;

wherein the stinger tube includes an aperture on the stinger tube adjacent to the cam, and

wherein to tighten the connection of the stinger tube within the hitch receiver of the motor vehicle, the drive end is configured to rotate causing the linkage to drive the cam follower, thereby rotating a top end of the cam to a location outside the aperture of the stinger tube, where the cam engages with the inside of the hitch receiver.

Item 27. The hitch tightening mechanism of item 26, wherein the linkage is a that is attached to the cam follower at a proximal end and the drive end at the distal end.

Item 28. The hitch tightening mechanism of item 27, wherein the rod is a threaded rod and/or a bent rod.

Item 29. The hitch tightening mechanism of any one of items 26-28, wherein the drive end comprises one or more indentations at its distal end configured to accommodate a tool for further rotation of the drive end, resulting in further tightening of the connection of the stinger tube within the hitch receiver.

Item 30. The hitch tightening mechanism of item 29, wherein the tool is hex key or a screwdriver or a straight edged tool.

Item 31. The hitch tightening mechanism of any one of items 26-30, further comprising a pin inserted within an opening in the stinger tube, wherein the opening is adjacent to the aperture and wherein the pin is configured to prevent the stinger tube from disconnecting from the hitch receiver while the top end of the cam is rotated outside of the aperture.

Item 32. The hitch tightening mechanism of item 31, wherein the opening is distal to the aperture, and the pin acts as a secondary safety mechanism to prevent dislodgment of the stinger tube from the hitch receiver.

Item 33. The hitch tightening mechanism of item 31, wherein the opening is proximate to the aperture, and wherein as the top end of the cam rotates to a location outside of the aperture, a bottom end of the cam presses against a portion of the pin within the stinger tube causing the pin to move proximally within the opening, thereby vertically tightening the connection of the stinger tube with the hitch receiver.

Item 34. The hitch mechanism of any one of items 26-33, further comprising an adaptor sleeve configured to removably attach to a proximal end of the stinger tube and configured to allow the stinger tube to securely attach to a hitch receiver with greater dimensions.

Item 35. The hitch mechanism of any one of items 26-34, wherein the stinger tube is sized to attach to a 1.25 inch hitch receiver.

Item 36. The hitch mechanism of any one of items 26-34, wherein the stinger tube is sized to attach to a 2 inch hitch receiver.

Item 37. A hitch tightening mechanism for a bike carrier system, comprising:

a stinger tube connected to a base of the bike carrier system, wherein the stinger tube is configured for placement within a hitch receiver of a motor vehicle at a proximal end of the stinger tube,

a linkage located within the stinger tube;

wedge block located within and operative connected to the stinger tube;

an actuator located within the stinger tube adjacent to the wedge block and connected to the linkage at a proximal end;

a drive end located at a distal end of the stinger tube, wherein the linkage is connected to the drive end at a distal end;

wherein the stinger tube includes an aperture on a side or corner of the stinger tube aligned with the wedge, and

wherein to tighten the connection of the stinger tube within the hitch receiver of the motor vehicle, the drive end moves the linkage to drive the actuator into the wedge block, thereby pushing a top end of the wedge block to a location outside the aperture of the stinger tube where the wedge block engages with the inside of the hitch receiver.

Item 38. The hitch tightening mechanism of item 37, wherein the wedge block and the actuator have opposing non-horizontal faces, wherein the linkage has at least one threaded interface, and rotation of the drive end drives the opposing face of the actuator into the opposing face of the wedge block, and thereby pushing the outer end of the wedge block to a location outside the aperture to engage with the inside of the hitch receiver.

Item 39. The hitch tightening mechanism of item 37 or 38, wherein the wedge block is pushed outward from the aperture at approximately a 45-degree angle to tighten into opposite two walls of the receiver tube to constrain the stinger tube both horizontally and vertically.

Item 40. The hitch tightening mechanism of item 37 or 38, wherein the stinger tube is configured to be inserted into a receiver tube that is imperfectly matched to the stinger tube dimensions, and wherein the wedge block and the aperture have sufficient clearance to allow the wedge block to protrude through the aperture and contact an inner wall of the receiver tube, thereby automatically tightening the mechanism in both horizontal and vertical orientations.

Item 40.1 The hitch tightening mechanism of item 37, wherein the drive end comprises one or more indentations at its distal end configured to accommodate a tool for further rotation of the drive end, resulting in further tightening of the connection of the stinger tube within the hitch receiver.

Item 40.2. The hitch mechanism of item 37, further comprising an adaptor and sleeve configured to removably attach to a proximal end of the stinger tube and wedge and configured to allow the stinger tube to securely attach to a hitch receiver with greater dimensions.

Item 41. The hitch tightening mechanism of any one of items 37-40, wherein the linkage is a rod, and wherein the rod can be a threaded rod that is threaded into the drive end at the distal end.

Item 42. The hitch tightening mechanism of any one of items 37-41, wherein the drive end comprises one or more indentations at its distal end configured to accommodate a tool for further rotation of the drive end, resulting in further tightening of the connection of the stinger tube within the hitch receiver.

Item 43. The hitch tightening mechanism of item 42, wherein the tool is hex key or a screwdriver or a straight edged tool.

Item 44. The hitch mechanism of any one of items 37-43, further comprising an adaptor sleeve configured to removably attach to a proximal end of the stinger tube and configured to allow the stinger tube to securely attach to a hitch receiver with greater dimensions.

Item 45. The hitch mechanism of any one of items 37-44, wherein the stinger tube is sized to attach to a 1.25 inch hitch receiver.

Item 46. The hitch mechanism of any one of items 37-44, wherein the stinger tube is sized to attach to a 2 inch hitch receiver.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It is also understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. An adjustable arm bike carrier system, comprising:
a base configured to attach to a motor vehicle;
at least one support member attached to the base and configured to support the first and second tires of a bicycle;
a pivot axle; and
an adjustable hook arm operatively connected to the at least one support member or the base at the pivot axle, the hook arm being configured to rotate about the pivot axle in both directions and configured to securely hold the front or rear tire of the bicycle on the bike carrier system, the hook arm comprising:
an arm portion operatively connected to the pivot axle, and
a hook portion having a mechanical constraint, wherein the mechanical constraint causes the hook portion to compress the front or rear tire of the bicycle and is unidirectional to continually provide contact of the hook portion with the tire.

2. The system of claim 1, wherein the hook arm further comprises:
a trigger located on or attached to the hook arm;
wherein the hook portion is operatively connected to the trigger, and wherein upon activation of the trigger, the hook portion is configured to extend outwardly.

3. The system of claim 1, further comprising:
an upper stop located on or about the at least one support member and configured to prevent upward rotation of the hook arm about the pivot axle past a predetermined angle relative to horizontal, and
wherein the hook arm is positioned at an angle such that hook portion needs to extend away from the tire for the hook arm to rotate toward the at least one support member.

4. The system of claim 3, wherein the predetermined angle is between approximately 45° and approximately 75° relative to horizontal.

5. The system of claim 3, wherein the predetermined angle is approximately 52° relative to horizontal.

6. The system of claim 3, wherein the upper stop prevents the hook from contacting a frame, fork, fenders, and/or rack of the bicycle.

7. The system of claim 1, further comprising:
a lower stop located on or about the at least one support member and configured to prevent downward rotation of the hook arm about the pivot axle past approximately 0 degrees relative to horizontal.

8. The system of claim 1, further comprising:
a rotational constraint mechanism located on or about the at least one support member and configured to prevent rotation of the hook arm about the pivot axle away from a predetermined angle relative to horizontal.

9. The system of claim 1, wherein the hook arm is operatively connected to a mechanical locking mechanism via a linkage, wherein upon activation of the trigger, at least a portion of the hook arm is configured to extend outwardly via the mechanical locking mechanism.

10. The system of claim 2, wherein the trigger is located at a proximal end of the hook portion.

11. The system of claim 9, wherein the mechanical locking mechanism is a ratchet mechanism.

12. The system of claim 11, wherein activation of the trigger causes the linkage to rotate a ratchet arm within the ratchet mechanism, such that the ratchet arm releases from the mechanism to allow the portion of the hook arm to extend.

13. The system of claim 1, wherein the mechanical constraint is a spring or an elastomer.

14. The system of claim 13, wherein the spring or elastomer is a constant force spring.

15. A carrier system comprising a bike interference adjustment device, the system comprising:
a base configured to attach to a motor vehicle;
at least one tire support member attached to the base, wherein the at least one tire support member is configured to support the tires of at least one bicycle;
at least one interference adjustment device located on the at least one tire support member, wherein the at least one interference adjustment device is configured to raise and lower a tire of the at least one bicycle located on the at least one tire support member.

16. The carrier system of claim 15, wherein the at least one interference adjustment device is configured to raise and lower the front or back tire of the at least one bicycle to different positions.

17. The carrier system of claim 15, wherein the location of the at least one interference adjustment device is adjustable along the length of the at least one tire support member.

18. A hitch tightening mechanism for a bike carrier system, comprising:
a stinger tube connected to a base of the bike carrier system, wherein the stinger tube is configured for placement within a hitch receiver of a motor vehicle at a proximal end of the stinger tube,
a linkage located within the stinger tube;
a cam and a cam follower operatively connected to one another and located within the stinger tube, wherein the linkage is connected to the cam follower at a proximal end of the linkage;
a drive end located at a distal end of the stinger tube, wherein the linkage is connected to the drive end at a distal end of the linkage;
wherein the stinger tube includes an aperture on the stinger tube adjacent to the cam, and
wherein to tighten the connection of the stinger tube within the hitch receiver of the motor vehicle, the drive end is configured to rotate causing the linkage to drive the cam follower, thereby rotating a top end of the cam to a location outside the aperture of the stinger tube, where the cam engages with the inside of the hitch receiver.

19. The hitch tightening mechanism of claim 18, wherein the linkage is a rod that is attached to the cam follower at a proximal end and the drive end at the distal end.

20. The hitch tightening mechanism of claim 19, wherein the rod is a threaded rod and/or a bent rod.
